(19) United States
(12) Patent Application Publication
(10) Pub. No.: US 2012/0025056 A1
(43) Pub. Date: Feb. 2, 2012

(54) FIXTURE FOR PROTECTIVE RAILING

(76) Inventors: Joakim SVEDBERG, Froson (SE); Anders WIKMYR, Goteborg (SE)

(21) Appl. No.: 13/130,149

(22) PCT Filed: Nov. 17, 2009
(86) PCT No.: PCT/EP2009/065283

§ 371 Date: Sep. 9, 2011

(30) Foreign Application Priority Data
Nov. 21, 2008 (EP) 08169641.1

(51) Int. Cl. F16M 13/00

(52) U.S. Cl. 248/686

(57) ABSTRACT

This invention relates to a concrete embedment fixture for mounting of protective railing. The fixture has a tubular member (3), at least one concrete inlet opening (11, 13) at a bottom end of the tubular member, and a plurality of brace elements (5) attached to an outer periphery of the tubular member. Each brace element has a sloping portion, which extends from an upper end towards a lower end thereof in a downwardly and outwardly sloping direction, wherein projections of at least two of the brace elements in a transversal plane of the tubular member extend in mutually different directions. Further, each brace element comprises, at the lower end thereof, an anchoring and supporting portion (5c) arranged to rest on a base and anchor the fixture in concrete.

### FIELD OF THE INVENTION

The present invention relates to a concrete embedment fixture for mounting a post of protective railing at a prefabricated concrete slab. The fixture comprises a tubular member having an upper and a lower end, and at least one concrete inlet opening into the tubular member. The fixture is thus intended to be cast into the prefabricated concrete slab.

### BACKGROUND OF THE INVENTION

SE 508 956 discloses a prior art fixture comprising a tubular member (2), an elongated plate shaped element (4) attached to the lower end of the tubular member, and a support pin (10) extending downwardly sloping from its upper end, which is attached to the periphery of the tubular member, and having its lower end attached to the top surface of the elongated plate shaped element. The plate shaped element defines two concrete inlet openings into the tubular member.

The prior art fixture is used as follows. At a production site for prefabricating concrete slabs, having arranged reinforcement bars of a concrete slab to be produced, the fixture is placed on top of some of the reinforcement bars and the plate shaped element is fastened at them by means of straps. Then the concrete is applied and covers the plate shaped element and a lower portion of the tubular member. Some amount of concrete enters the interior space of the tubular member from below through the concrete inlet openings. The prefabricated concrete slabs are then transported to a building site where they are mounted in place. Then posts are mounted in the fixtures, and railing nets or bars are mounted on the posts.

The concrete slabs serve as cast moulds, and further concrete is cast on top of the concrete slabs. The prior art fixture is useful on the building site as well, were it is similarly arranged on the reinforcement bars in a cast mould before casting.

Another prior art fixture is disclosed in US2007/0137135. That fixture comprises a tubular member and a plurality of brace elements. It is intended to be secured to a formwork by for example nails to remain in position during casting of the concrete. The fixture can however not be used to install a temporary protective railing until the casting is done and the concrete has reached a necessary level of strength. This means, that somebody working on the formwork, e.g. with casting, is not prevented from falling down by a protective railing. The use of the fixture of US2007/0137135 in a prefabricated concrete slab as formwork, as disclosed in SE 508 956 and within the field of the present invention as mentioned above, would not be feasible. This since the fixture of US2007/0137135 lacks the necessary rigidity. The main purpose of the fixture in US2007/0137135 is to provide a hole in the concrete into which a post can be inserted, not to provide any rigidity itself.

### SUMMARY OF THE INVENTION

It is an object of the present invention to provide an improved fixture.

This object is achieved by a fixture according to the present invention as defined in claim 1 of the appended claims.

Thus, in accordance with an aspect of the present invention, there is provided a concrete embedment fixture for mounting of protective railing at a prefabricated concrete slab. The fixture comprises a tubular member having a top end and a bottom end, and a plurality of brace elements attached to an outer periphery of said tubular member. There is at least one concrete inlet opening into the tubular member at the bottom end thereof. Each one of the brace elements has an upper end and a lower end, and has a sloping portion that extends from the upper end towards the lower end in a downwardly and outwardly sloping direction. Projections of at least two of the brace elements in a transversal plane, i.e. transversal in relation to the tubular member which, as understood by a person skilled in the art, has a longitudinal axis, extend in mutually different directions. In a typical state of usage, the transversal plane equals to a horizontal plane. Each brace element comprises an anchoring and supporting portion, at the lower end thereof, arranged to rest on a base and to anchor the fixture in the concrete. It should be noted that the expression “concrete embedment fixture” is to be understood as a fixture that is arranged to be at least partially embedded in concrete.

In accordance with an embodiment of the fixture, the brace elements are attached in an uniformly spaced manner along the circumference of the tubular member.

In accordance with an embodiment of the fixture, the brace elements are constituted by brace rods, each having an attachment portion at an upper end of the brace rod attached to the tubular member at the top end thereof, and each having a free lower end.

In accordance with embodiments of the fixture, a major part of the anchoring and supporting portion extends either perpendicularly to the longitudinal axis of the tubular member, or obliquely downwards and inwards.

In accordance with an embodiment of the fixture, the anchoring and supporting portion comprises a non-corrosive spacer. The spacer constitutes the part that is arranged to rest on a base. It should here be noted that a typical embodiment of the fixture has a body of a corrosive material, which advantageously is fully embedded into the concrete.

In accordance with embodiments of the fixture, the spacer is constituted by a cover layer, which has been applied to a centre body of the brace rod, or a disc shaped spacer element, which has been mounted on the centre body.

In accordance with an embodiment of the fixture, the brace elements are constituted by brace fins, each having an inner edge extending along at least a major part of, and attached to, the tubular member, an outer edge, which constitutes the sloping portion mentioned above, and a bottom edge extending from said inner edge to said outer edge, wherein said anchoring and supporting portion is provided at said bottom edge.

In accordance with an embodiment of the fixture, each brace fin, and more particularly, each anchoring and support portion, comprises an anchoring lip extending along said bottom edge in a plane extending transversally of the tubular member.

In accordance with an embodiment of the fixture, the spacer is constituted by a pointed element, which has been mounted on the anchoring lip. The pointed element is turned point down, and protrudes downwards from the lip.

In accordance with an embodiment of the fixture, a removable top cover is provided at the top end of the tubular member, covering said top end, and wherein a removable dowel extends through said cover, and the tubular member. Furthermore, the dowel extends below the bottom end of the tubular member at least to such an extent that it reaches a plane defined by lower most portions of the brace elements. In other words, the dowel will reach down to the base that the brace elements rest upon.

In accordance with an embodiment of the fixture, a telescopically displaceable extension sleeve is provided inside the tubular member. In this embodiment, the above-mentioned removable bottom cover is alternatively arrangeable at the bottom end of the extension sleeve.

In accordance with an embodiment of the fixture, it comprises a post stop, which is arranged at the bottom end of the tubular member.

In accordance with an embodiment of the fixture, the post stop is a plate shaped element, which is attached to the bottom end of the tubular member, and which defines the concrete inlet opening or openings.

These and other embodiments, and aspects, features, and advantages of the invention will be apparent from and elucidated with reference to the embodiments described hereinafter.

### BRIEF DESCRIPTION OF THE DRAWINGS

The invention will now be described in more detail and with reference to the appended drawings in which:

FIG. 1 is a perspective view from below of a first embodiment of a fixture according the present invention;

FIGS. 2-4 are respectively top perspective, side and top views of the fixture shown in FIG. 1;

FIG. 5 is a side view of the fixture in FIG. 1 completed with spacer means;

FIGS. 6-8 show a second embodiment of a fixture according to the present invention;

FIGS. 9-15 illustrate one application of the fixture according to the present invention;

FIGS. 16 and 17 show a third embodiment of a fixture according to the present invention;

FIG. 18 shows a third embodiment of a fixture according to the present invention;

FIG. 19 shows a fourth embodiment of a fixture according to the present invention;

FIG. 20 shows a fifth embodiment of a fixture according to the present invention;

FIG. 21 shows a part of a fixture according to a sixth embodiment thereof;

FIG. 22 shows a seventh embodiment of a fixture according to the present invention; and

FIGS. 23-25 are principle views illustrating different brace element distributions.

### DESCRIPTION OF PREFERRED EMBODIMENTS

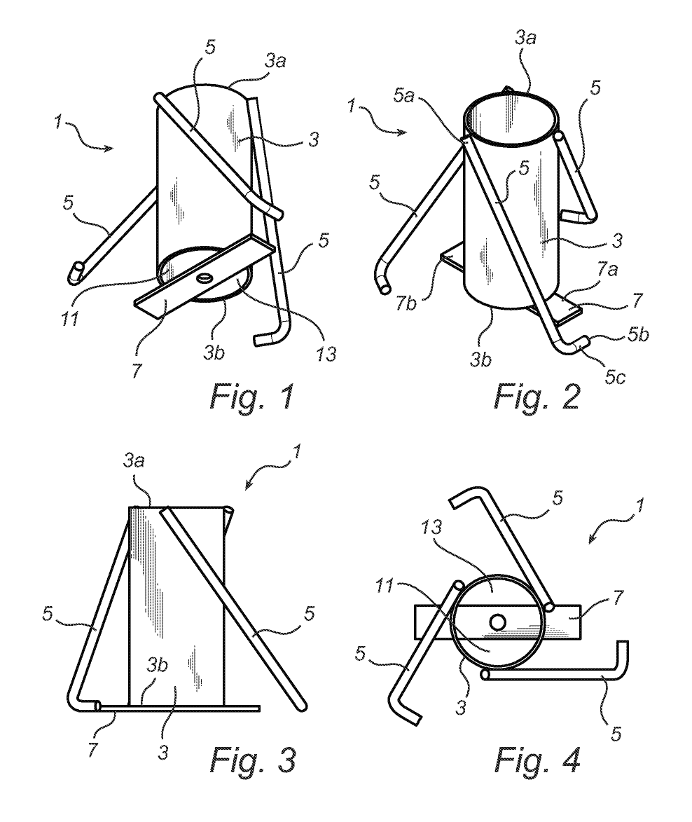

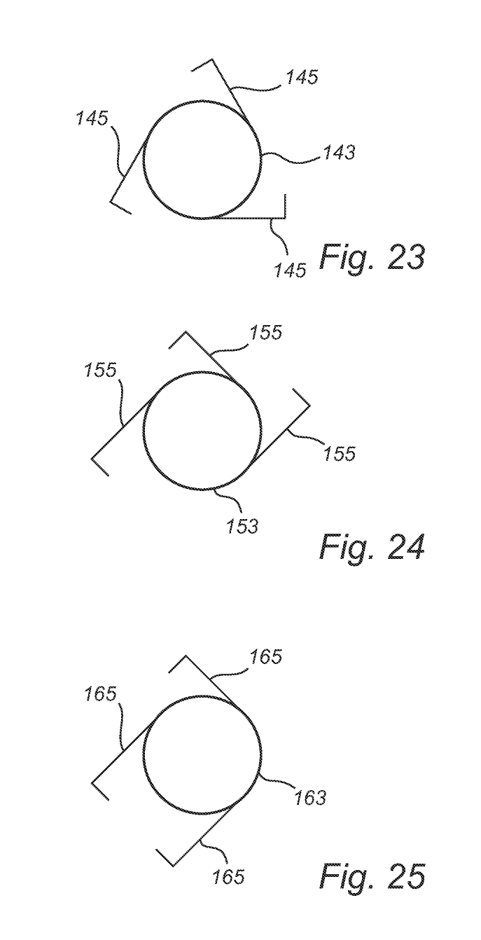

In a first embodiment, as shown in FIGS. 1 to 4, the fixture 1 comprises a tubular member 3, three brace elements 5, constituted by brace rods, and a post stop constituted by a plate shaped element 7, below also called bottom plate. In this embodiment the tubular member 3 is a tube 3 having a circular cross section. However other cross-sectional shapes are applicable, such as square, etc. The tube 3 has a top end 3a and a bottom end 3b. Each brace rod 5 has an upper end 5a and a lower end 5b, and is attached to the tube 3 at the upper end 5a. More particularly, an attachment portion of each brace rod 5, extending along a minor part of the rod 5 in the vicinity of or including the very upper end 5a thereof, is attached to the peripheral surface of the tube 3 at the top end 3a of the tube 3, i.e. within a top most portion of the tube 3. It is not necessary but advantageous to attach the brace rods 5 to the tube 3 at the top end thereof, and it is at least preferred to attach the rods 5 at an upper half of the tube 3. A sloping portion of each brace rod 5, which in this embodiment is most of the brace rod 5, extends obliquely downwards and outwards in a vertical geometric plane, which additionally extends tangentially of the tube 3. The brace rods 5 are spaced around the tube 3, and consequently they extend in mutually different directions. In other words, projections of the brace rods 5 in a transversal plane of the tubular member 3 extend in mutually different directions. This is also illustrated in FIG. 23, which most schematically shows this principle, wherein the brace rods are denoted by 135 and the tubular member by 133. Having at least two of the brace rods 5 extending in different directions, e.g. provides for an enhanced capability of the fixture 1 to resist forces in multiple directions. In this embodiment the brace rods 5 are uniformly spaced along the circumference of the tube 3. However, as an alternative, which for instance can be advantageous for shipping reasons, the brace rods 145 are non-uniformly spaced around the tube 143, as illustrated by FIG. 24, and/or some of the brace rods can extend in the same direction, like two of the brace rods 165 shown in FIG. 25.

Each brace rod 5 includes an anchoring and supporting portion 5c at the lower end 5b thereof. Each one of the anchoring and supporting portions 5c, or at least a centre axis thereof, basically extends perpendicular to the longitudinal axis, i.e. the centre axis, of the tubular member 3, although, as will be explained below, these portions 5c comprise respective parts which may have a different main direction of extension. When the fixture 1 has been positioned for casting, the anchoring and supporting portions 5c rest on the base, typically a cast mould, and thereby support the fixture 1. Further, the anchoring and supporting portions 5c contribute to the strength of the concrete bond after having finished casting. Consequently, the brace rods 5 are both supportive as they inter alia prevent the fixture from turning over, and anchoring since they, and in particular the anchoring and supporting portions 5c, provide a part, or even a major part, of the strength, regarding laterally as well as longitudinally directed forces, after having cast the fixture into concrete of a prefabricated slab, as will be further explained below. Below, the “anchoring and supporting portions” will also be referred to as “support portions”, for reasons of simplifying the description.

The bottom plate 7 also contributes to the strength by means of the end portions 7a, 7b, which extend beyond, i.e. outside of the outer periphery of the tube 3. Consequently, after being cast into concrete these end portions 7a, 7b are attached to the concrete as well. For instance, the bottom plate 7 takes momentum in the tube 3 created by the brace rods 5. Additionally, when later on mounting a post 115, see FIG. 14, the bottom plate 7 prevents the post 115 from punching a hole in the concrete layer beneath the tube 3.

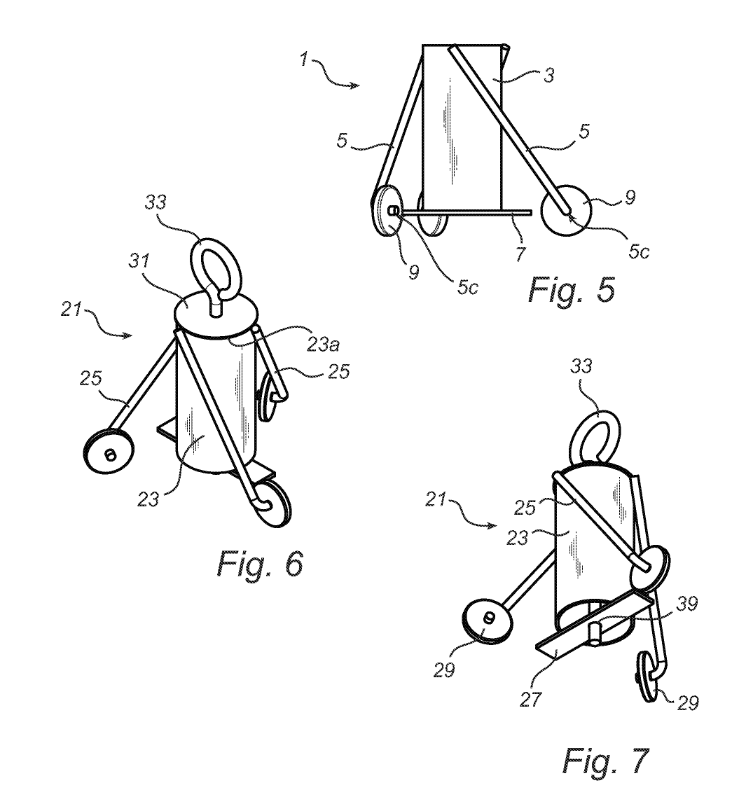

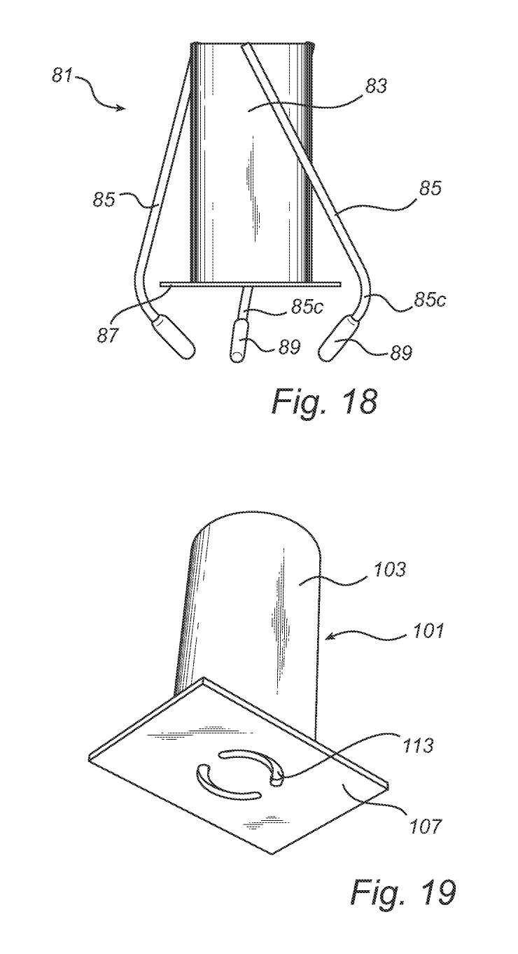

The support portion 5c of each brace rod 5 comprises a spacer 9, as shown in FIG. 5, which typically is either cover layer portion, as shown at 89 in FIG. 18, of the brace rod 5, or a separate part that has been mounted at a lower end portion of a metal centre body of the brace rod 5 comprised in the support portion 5c. In this embodiment the spacer 9 of each brace rod 5 constitutes a disc, which has been mounted on a lower end portion of the brace rod 5. The lower end portion has been bent at right angle close to the lower end 5b of the brace rod 5. The lower surface of the lower end portion 5c is coplanar with the lower surface of the bottom plate 7, i.e. they are co-located in a transversal plane, while the spacer 9 extends below that lower surface. The diameter of the spacer 9 determines the distance from the base to the lower surface of the bottom plate 7, and to the lower surface of the lower end portion 5c of the centre body of the brace rod 5, and can be made optional by providing different sizes of the spacer 9. The spacers 9 are non-corrosive. Typically, the spacers 9 are formed from plastic, while the rest of the support portions 5c, and of the whole fixture 1, is made from iron. Thereby, there will be no risk of corrosion at the small portions of the fixture that may end up non-covered by concrete (see below for a description of the casting procedure) due to their abutment against a base, i.e. the lower most portions of the support portions 5c. The spacers 9 can have many different shapes, such as having a lacinated or a tooth profiled peripheral flange.

The bottom plate 7 defines concrete inlet openings 11, 13 into the tube 3 at either side of the bottom plate 7. Thus, the width of the bottom plate is more narrow than the inner diameter of the tube 3. The openings 11, 13 are arranged in order to let concrete into the tube 3, as will be further described below. Other embodiments are however applicable as well. For example, as shown most schematically in FIG. 18, in an alternative embodiment the bottom plate 107 covers the whole bottom end of the tubular member 101. The concrete inlet openings are provided by apertures 111, 113 of the bottom plate 107. More particularly, the apertures are constituted by arc shaped through holes 111, 113, which are large enough for letting the concrete pass into the tube 103 during the casting.

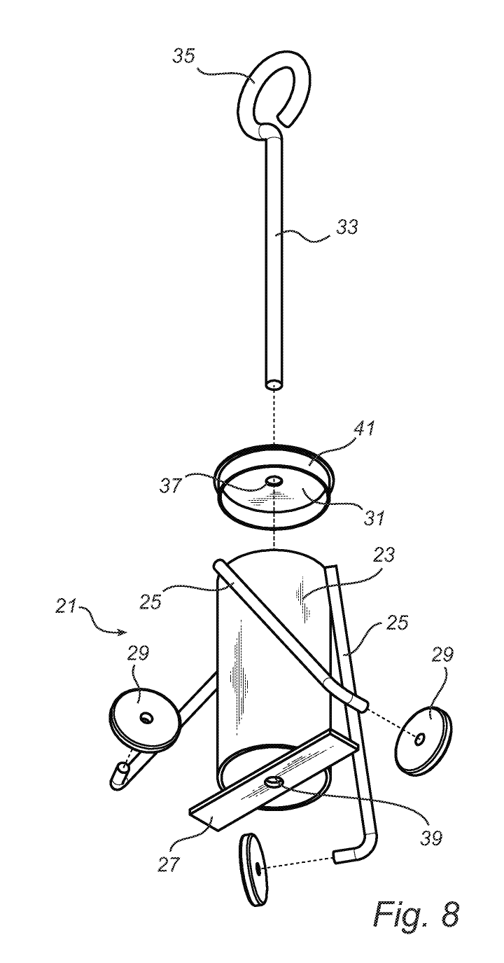

Referring to FIGS. 6-8, another embodiment of the fixture 21 comprises the similar main parts as the above-described fixture 21, i.e. a tubular member 23, brace elements 25 comprising spacers 29, and a plate shaped element, or bottom element, 27. However, the fixture 21 additionally comprises a removable top cover 31, which is provided at the top end 23a of the tubular member 23, and a removable dowel 33, which extends coaxially with the tubular member 23, i.e. in alignment with the longitudinal axis of the tubular member 23, through the cover 31, through the tubular member 23, and through the bottom element 27. For this matter the top cover 31 and the bottom element 27 are provided with through holes 37 and 39, which are aligned. The dowel 33 comprises a hoisting lug 35, thereby facilitating removal of the dowel. The dowel 33 protrudes beyond, i.e. below, the bottom plate 27, such that the lower end of the dowel is coplanar with the lowest portions of the spacers 29. The top cover and dowel assembly prevents undesired material, such as concrete, water or litter, from entering the tube 23. Additionally, the dowel 33, when embedding a lower part of the fixture 21 during casting of the prefabricated concrete element, as will be explained below, the dowel 33 will form a hole through the concrete element, which is useful as a drainage hole when later on removing the top cover 31 and the dowel 33. Referring in particular to FIG. 8, a lower surface of the removable top cover 31 is provided with a cylindrical rim 41 extending downwards. The outer diameter of the rim 41 corresponds to an inner diameter of the tubular member 23, i.e. the cover 31 is mounted with tight fit, however loose enough to be removable. Preferably, the cover is made from plastic, or waxed paper.

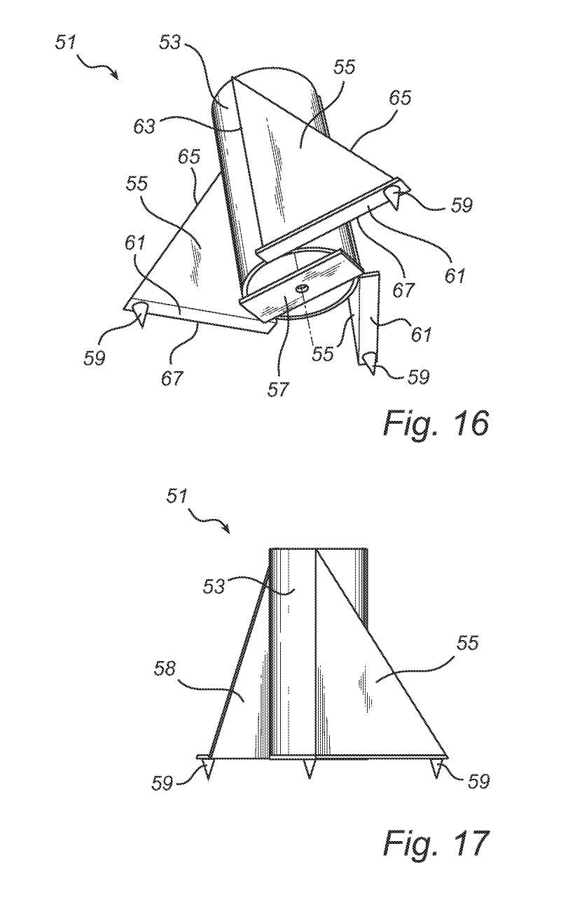

In accordance with another embodiment of the fixture 51, as shown in FIGS. 16 and 17, the brace elements 55 are constituted by brace fins, which are basically triangular. Each brace fin 55 has an inner edge 63, which is attached to the periphery of the tubular member 53, and extends along at least a major part of the length thereof. Further, each brace fin 55 has a downwardly and outwardly sloping outer edge 65, or sloping portion, and a bottom edge 67 extending from said inner edge 63 to the outer edge 65. An anchoring and supporting portion is arranged at the bottom edge 67, and includes an anchoring lip 61, which extends along the bottom edge 67 and in parallel with the plate shaped element 57, and a spacer element 59. The anchoring lips 61 extend in a transversal plane, i.e. transversal of the tubular member 53. The spacer element 59 is a pointed element, and more particularly a cone having a longitudinal axis extending in parallel with the longitudinal axis of the tubular member 53. The base of the cone 59 is attached to the anchoring lip 61, and thus the tip of the cone 59 protrudes downwards into contact with the base. The anchoring lips 61 provide a substantial contribution to the strength of the concrete bond.

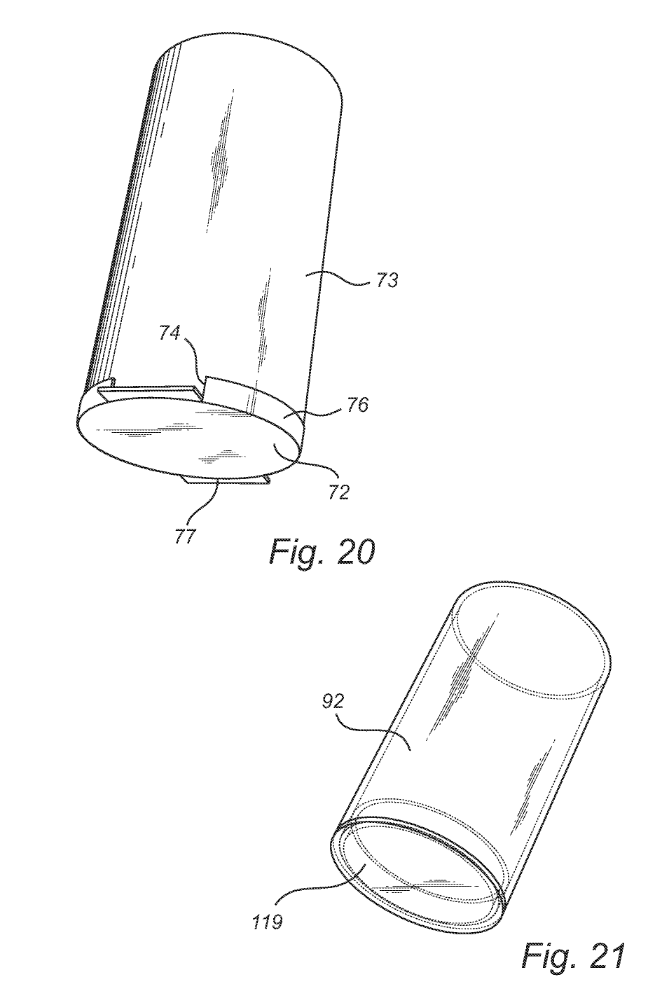

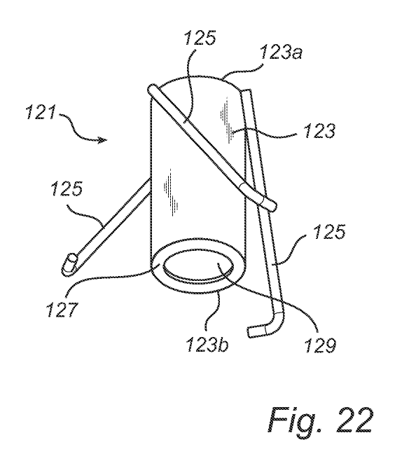

In accordance with another embodiment of the fixture, a removable bottom cover 72 is provided at the bottom end of the tubular member 73, as indicated most schematically for any structure of the rest of the fixture in FIG. 20. The removable bottom cover 73 is for instance advantageous when the fixture is placed on a base upon which concrete will be cast to full height in a single step. Without bottom end coverage the tubular member would otherwise be filled to such an extent that a post would be prevented from entering the tubular member. By means of the bottom cover 72 it is possible to use those embodiments which have concrete inlet openings in the bottom. Here the bottom cover comprises a collar 76 extending outside of the tubular member 73. When appropriate the collar 76 is provided with cuts 74 for receiving the protruding ends of the bottom plate 77.

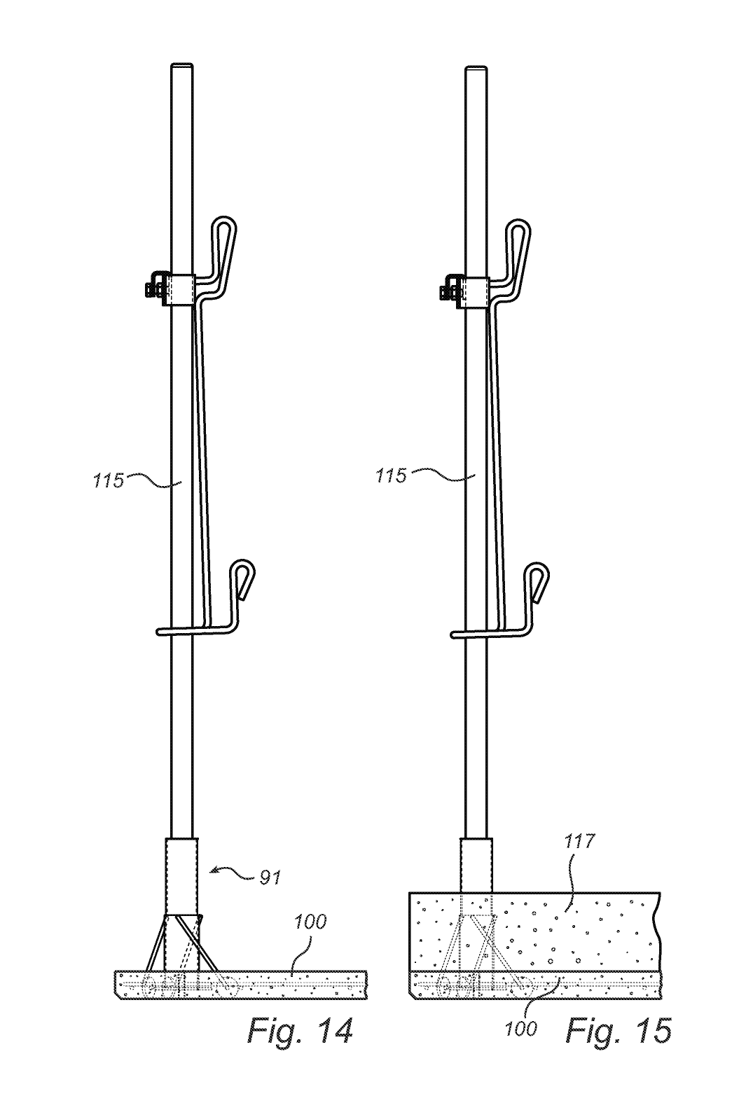

According to another embodiment of the fixture, as shown for instance in FIGS. 12 and 13, it comprises an extension sleeve 92, which is inserted into the tubular member 93, and which is telescopically displaceable relative to the tubular member 93. Preferably, the extension sleeve is made from plastic. In embodiments having an extension sleeve 92, it can be advantageous to provide the bottom end of the sleeve 92, instead of the tubular member, with a bottom cover 119, see FIG. 21.

As mentioned above, the brace elements each have a support portion, which includes a spacer. An alternative embodiment of the spacer is shown in FIG. 18. The fixture 81 comprises brace elements constituted by brace rods 85. The spacer 89 of each brace rod 85 is a plastic sleeve, or a plastic cover layer, that has been applied in a suitable manner onto a centre body of the support portion 85c of the brace rod 85, e.g. by dipping the centre body of the support portion 85c into melted plastic. Further, this figure exemplifies another alternative feature of the fixture. Not only the spacer means 89 but the whole support portion 85c of each brace rod 85 extends below the lower surface of the bottom plate 87, and, consequently, below a transversal plane located at the bottom end rim of the tubular member 83. Furthermore, in this embodiment the support portions 89 extend obliquely downwards and inwards, i.e towards the centre of the tubular member 83.

According to another embodiment of the fixture 121, the post stop is embodied as a bottom ring 127 at the bottom end 123b of the tubular member 123. The ring narrows the bottom hole 129 compared to hole of a fully open tubular member 123. The ring could be regarded as a flange extending over a distance transversally inwards of the tubular member 123. There are both advantages and disadvantages of the bottom ring compared to the bottom plate. It should be noted that it may not be essential for the function of the fixture to have a post stop, but it is generally advantageous to have a post stop at the bottom end of the tube in comparison to have no post stop.

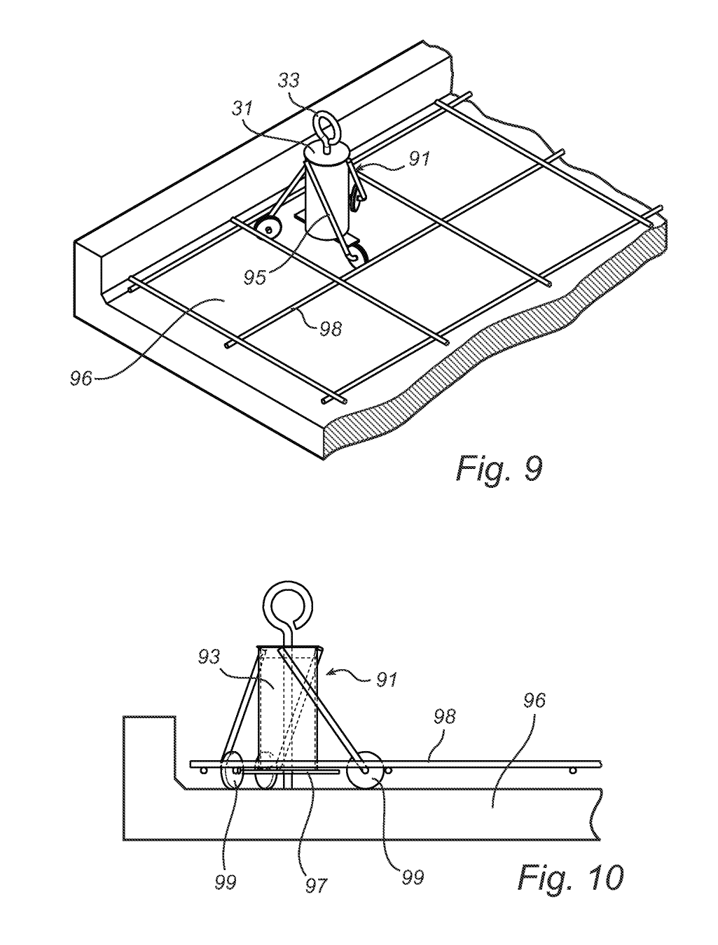

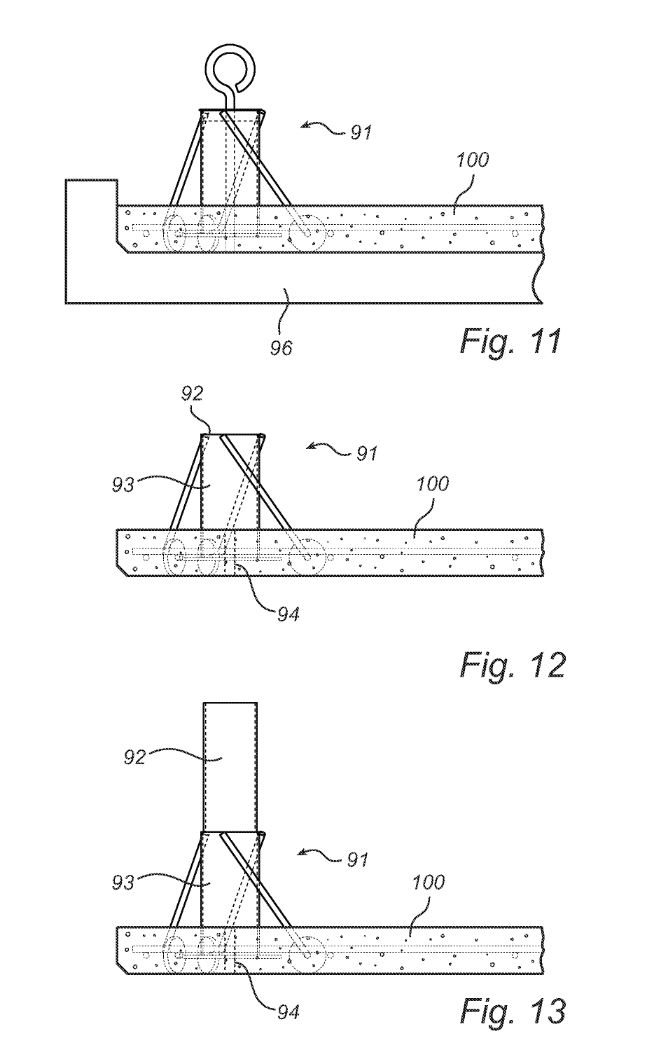

The fixture is arranged to be embedded in the concrete of a prefabricated concrete slab. Referring to FIGS. 9 to 15, the fixture 91 is placed on top of a cast mould 96, which thus constitutes the base. The cast mould 96 is provided with a mesh of reinforcement bars 98. The fixture 91 is placed between the bars 98 such that it stands directly on the top surface of the mould 96, i.e. the spacers 99 of the brace elements 95 rest on the mould 96. The fixture comprises the top cover and dowel 33 assembly. The size of the spacers 99 is chosen such that the bottom end of the tubular member 93 and the bottom plate 97 are approximately coplanar with the reinforcement bars 98. Then concrete is filled into the mould 96 such that a concrete layer 100 is formed. The thickness of the concrete layer 100 is enough for the concrete to cover the reinforcement bars 98 and the support portions of the brace elements 95 including the spacers 99. Due to the concrete inlet openings defined by the bottom plate 97 an amount of concrete enters the tubular member 93. The top surface of the concrete within the tubular member 93 approximately is aligned with the top surface of the concrete layer 100 outside of the tubular member 93. Then the thus prefabricated concrete slab is transported to the construction site, where it is mounted in place. The top cover 31 and the dowel 33 are removed, the dowel leaving a hole through the concrete slab. This hole 94 serves as a drain hole. Next the extension sleeve 92 is displaced, i.e. lifted up, to an extracted position, see FIG. 13, and a post 115 is mounted, i.e. inserted, in the fixture 91. Next a mesh panel (not shown) is mounted on several posts 115. At this point it is necessary that the fixture 91 is properly anchored in the relatively thin prefabricated concrete slab 100, such that it does not loosen due to bending forces that may occur during the mounting of the protective railing or after it has been mounted. The structure of the fixture 91 according to this invention provide sufficient strength in the concrete bond to withstand such forces, while the prior art fixture initially described provided a weaker bond. The prior art fixture was fastened on top of the reinforcement bars. Recent years the prefabricated concrete slabs have been made thinner and thinner, resulting in a too thin concrete layer on top of the fixture being liable to crack. The construction of the prior art fixture contributed to this liability, while the construction of the present fixture provides an improved strength of the bond. Finally, the finishing casting is performed, where concrete is added to such a level that the tubular member 93 and a portion of the extension sleeve 92 are covered by the concrete 117. It should be noted that of course not only the particular embodiment shown in FIGS. 9 to 15 is useful for this application but all embodiments of the fixture.

Above, embodiments of the fixture according to the present invention have been described. These should be seen as merely non-limiting examples. As understood by a skilled person, many modifications and alternative embodiments are possible within the scope of the invention as defined in the appended claims.

It is to be noted, that for the purposes of this application, and in particular with regard to the appended claims, the word “comprising” does not exclude other elements or steps, that the word “a” or “an”, does not exclude a plurality, which per se will be apparent to a person skilled in the art.

1. A concrete embedment fixture for mounting of protective railing at a prefabricated concrete slab, said fixture comprising a tubular member having a top end and a bottom end, at least one concrete inlet opening at the bottom end of said tubular member, and a plurality of brace elements attached to an outer periphery of said tubular member, wherein each one of said brace elements has an upper end and a lower end, and has a sloping portion extending from the upper end towards the lower end in a downwardly and outwardly sloping direction, wherein projections of at least two of the brace elements in a transversal plane of the tubular member extend in mutually different directions, and wherein each brace element comprises, at the lower end thereof, an anchoring and supporting portion (5c, 85c) arranged to rest on a base and anchor the fixture in concrete.

2. A fixture according to claim 1, wherein the brace elements are attached in a uniformly spaced manner along the circumference of the tubular member.

3. A fixture according to claim 1, wherein said brace elements are constituted by brace rods, each having an attachment portion at an upper end of the brace rod attached to the tubular member at the top end thereof, and each having a free lower end.

4. A fixture according to claim 3, wherein a major part of said anchoring and supporting portion extends perpendicularly to the longitudinal axis of the tubular member.

5. A fixture according to claim 3, wherein a major part of said anchoring and supporting portion extends obliquely downwards and inwards.

6. A fixture according to claim 3, wherein said anchoring and supporting portion comprises a non-corrosive spacer, which is arranged to rest on said base.

7. A fixture according to claim 6, wherein said spacer is constituted by a cover layer, which has been applied to a centre body of the brace rod.

8. A fixture according to claim 6, wherein said spacer is constituted by a disc shaped spacer element, which has been mounted on a centre body of the brace rod.

9. A fixture according to claim 1, wherein said brace elements are constituted by brace fins, each having an inner edge extending along at least a major part of, and attached to, the tubular member, an outer edge constituting said sloping portion, and a bottom edge extending from said inner edge to said outer edge, wherein said anchoring and supporting portion is provided at said bottom edge.

10. A fixture according to claim 9, wherein said anchoring and supporting portion comprises an anchoring lip extending along said bottom edge in a transversal plane of said tubular member.

11. A fixture according to claim 10, wherein said anchoring and supporting portion comprises a non-corrosive spacer, which is constituted by a pointed element mounted on, and extending downwards from, said anchoring lip.

12. A fixture according to claim 1, wherein a removable top cover is provided at the top end of the tubular member, covering said top end, and wherein a removable dowel extends through said cover, and said tubular member, and protrudes below the bottom end of the tubular member at least to such an extent that it reaches a plane defined by lower most portions of the brace elements.

13. A fixture according to claim 1, wherein a telescopically displaceable extension sleeve is provided inside the tubular member.

14. A fixture according to claim 1, further comprising a post stop arranged at the bottom end of the tubular member.

15. A fixture according to claim 14, wherein said post stop comprises a plate shaped element attached to the bottom end of the tubular member, wherein said plate shaped element defines said at least one concrete inlet opening.
